(19) United States
(12) Patent Application Publication
(10) Pub. No.: US 2013/0258734 A1
(43) Pub. Date: Oct. 3, 2013

(54) APPARATUS FOR CONTROLLING VOLTAGE CONVERTING APPARATUS

(71) Applicants: Miyoko NAKANO, Susono-shi (JP); Masashi KOBAYASHI, Gotenba-shi (JP)

(72) Inventors: Miyoko NAKANO, Susono-shi (JP); Masashi KOBAYASHI, Gotenba-shi (JP)

(21) Appl. No.: 13/839,576

(22) Filed: Mar. 15, 2013

(30) Foreign Application Priority Data
Mar. 28, 2012 (JP) 2012-074123

(51) Int. Cl. H02M 7/537

(52) U.S. Cl. CPC H02M 7/537
USPC 363/131

(57) ABSTRACT

An apparatus for controlling a voltage converting apparatus controls a voltage converting apparatus capable of performing one-arm drive using either a first arm or a second arm by alternatively switching on a first switching element and a second switching element each of which is connected to a reactor in series. The apparatus for controlling the voltage converting apparatus is provided with: a current detecting device for detecting a reactor current; an average value estimating device for estimating an average value of the reactor current in units of periods of a gate signal for changing on and off of each of the first switching element and the second switching element, by using the detected reactor current; and a controlling device for controlling operation of the voltage converting apparatus on the basis of the estimated average value of the reactor current.

### BACKGROUND OF THE INVENTION

1. Field of the Invention

The present invention relates, for example, to an apparatus for controlling a voltage converting apparatus mounted on a vehicle or the like.

2. Description of the Related Art

Recently, as an environmentally-friendly vehicle, attention has been drawn to an electrically-driven vehicle which is equipped with an electrical storage device (such as for example, a secondary battery and a capacitor) and which drives using a driving force generated from electric power stored in the electrical storage device. The electrically-driven vehicle includes, for example, an electric vehicle, a hybrid vehicle, a fuel-cell vehicle, or the like.

The electrically-driven vehicle is provided, in some cases, with a motor generator which generates the driving force for driving in response to the electric power from the electrical storage device upon departure and acceleration, and which generates electricity due to regenerative braking upon braking and stores electrical energy in the electrical storage device. As described above, the electrically-driven vehicle is equipped with an inverter in order to control the motor generator in accordance with a travelling state.

The vehicle as described above is provided, in some cases, with a voltage converting apparatus (a converter) between the electrical storage device and the inverter in order to stably supply electric power which is used by the inverter and which varies depending on a vehicle state. The converter sets an input voltage of the inverter, which is higher than an output voltage of the electrical storage device, thereby allowing high output of a motor. The converter also reduces a motor current in the same output, thereby allowing a compact, low-cost inverter and motor.

For further improvement of fuel efficiency of the electrically-driven vehicle, it is important to reduce a loss of the converter and to improve efficiency. Thus, for example, Patent documents 1 to 3 have suggested a technology of switching-driving a boost converter using one arm. According to such a technology, it is considered that the loss of the converter can be reduced by an amount of reduction in current ripple.
Patent Document 1: Japanese Patent Application Laid Open No. 2011-120329
Patent Document 2: Japanese Patent Application Laid Open No. 2006-074932
Patent Document 3: International Publication No. 2010-137127

The operation of the converter is controlled on the basis of an average value of an electric current flowing through a reactor. If, however, the aforementioned one-arm drive is performed, a negative current cannot be applied when an arm corresponding to a positive current is driven, and the positive current cannot be applied when an arm corresponding to the negative current is driven. Thus, if a reactor current is near zero, the average value of the reactor current is hardly obtained in a normal method.

Specifically, the average value of the reactor current is detected, for example, by sampling the reactor current in timing according to a carrier signal for generating a gate signal which changes on and off of switching elements. This uses that a peak and a bottom of the carrier signal are almost intermediate points of change timing of the switching elements (in other words, the peak and the bottom of the reactor current).

In contrast, if the one-arm drive is performed, the electric current can be applied only in one of polarities, and non-linear control is thus performed when the reactor current is near zero. Thus, the peak and the bottom of the carrier signal are shifted from the intermediate points of the change timing of the switching elements. Therefore, even if the reactor current is sampled in the timing based on the carrier signal, an accurate average value cannot be estimated.

As described above, the one-arm drive described in the Patent documents 1 to 3 described above has such a technical problem that it is hard to accurately detect the average value of the reactor current near zero.

### SUMMARY OF THE INVENTION

It is therefore an object of the present invention to provide an apparatus for controlling a voltage converting apparatus capable of estimating the average value of the reactor current, highly accurately, in the voltage converting apparatus for performing the one-arm drive.

The above object of the present invention can be achieved by an apparatus for controlling a voltage converting apparatus capable of performing one-arm drive using either a first arm including a first switching element or a second arm including a second switching element by alternatively switching on the first switching element and the second switching element each of which is connected to a reactor in series, said apparatus provide with: a current detecting device for detecting a reactor current which is an electric current flowing through the reactor; an average value estimating device for estimating an average value of the reactor current in units of periods of a gate signal for changing on and off of each of the first switching element and the second switching element, by using the detected reactor current; and a controlling device for controlling operation of the voltage converting apparatus on the basis of the estimated average value of the reactor current.

The voltage converting apparatus of the present invention is, for example, a converter mounted on a vehicle, and is provided with the first switching element and the second switching element each of which is connected to the reactor in series. As the first switching element and the second switching element, for example, an insulated gate bipolar transistor (IGBT), a power metal oxide semiconductor (MOS) transistor, a power bipolar transistor, or the like can be used.

Incidentally, to each of the first switching element and the second switching element, for example, a diode is connected in parallel to form respective one of a first arm and a second arm. In other words, the first switching element forms the first arm, and a switching operation thereof allows on and off of drive in the first arm to be changed. In the same manner, the second switching element forms the second arm, and a switching operation thereof allows on and off of drive in the second arm to be changed.

Moreover, the voltage converting apparatus of the present invention can realize the one-arm drive using either the first arm including the first switching element or the second arm including the second switching element by alternatively switching on the first switching element and the second switching element.

If the one-arm drive is performed, it is determined which arm of the first arm and the second arm is used to perform the one-arm drive, for example, on the basis of a voltage value, a current value, or the like to be outputted. More specifically, for example, the one-arm drive using the first arm is selected if a motor generator connected to the voltage converting apparatus performs a regeneration operation, and the one-arm drive using the second arm is selected if the motor generator performs a power running operation. As described above, at the time of one-arm drive, the one-arm drive using the first arm and the one-arm drive using the second arm are changed, as occasion demands.

The apparatus for controlling the voltage converting apparatus of the present invention is an apparatus for controlling the operation of the voltage converting apparatus described above, and can adopt forms of various computer systems, such as various microcomputer apparatuses, various controllers, and various processing units, like a single or plurality of electronic control units (ECUs), which can include, as occasion demands, one or a plurality of central processing units (CPUs), micro processing units (MPUs), various processors, various controllers, or further include various storing devices, such as a read only memory (ROM), a random access memory (RAM), a buffer memory, or a flash memory.

In operation of the apparatus for controlling the voltage converting apparatus of the present invention, the reactor current, which is an electric current flowing through the reactor, is detected by the current detecting device. The current detecting device is provided, for example, with a current sensor disposed around the reactor, an analog-to-digital converter (ADC) for sampling the reactor current in appropriate timing, and the like.

If the reactor current is detected, the average value of the reactor current is estimated by the average value estimating device. Here, particularly in the present invention, the average value of the reactor current is calculated in units of periods of the gate signal for changing the on and off of each of the first switching element and the second switching element. Specifically, the average value of the reactor current is calculated as the average value in one period of the gate signal (e.g., a period from rise timing to next rise timing of the gate signal)

As a method of estimating the average value of the reactor current, for example, there is a possible method of sampling the reactor current on the basis of a carrier signal to perform calculation. However, if the one-arm drive is performed, an electric current can be applied only in one polarity as long as the arm is not changed. Thus, there may be a situation in which a correspondence between the carrier signal and the reactor current is different from the case of normal drive (i.e. drive which is not the one-arm drive). For example, in the one-arm drive, non-linear control is performed if the reactor current is near zero, and thus, periodic fluctuation of the reactor current is temporarily disrupted. Thus, even if the average value is calculated on the basis of the carrier signal, the calculated average value is unlikely an accurate value if the one-arm drive is performed.

In the present invention, however, as described above, the average value of the reactor current is estimated in units of periods of the gate signal. Here, regarding the period of the gate signal, a correspondence thereof with the reactor current does not fall even in the one-arm drive, unlike the carrier signal. More specifically, the reactor current starts to increase in the rise timing of the gate signal, and starts to decline in fall timing of the gate signal. Therefore, if the average value is calculated in units of periods of the gate signal, it is possible to estimate an accurate value even in the case of the one-arm drive.

If the average of the reactor current is calculated, the voltage converting apparatus is controlled by the controlling device on the basis of the estimated average value of the reactor current. For example, a duty ratio of the first switching element and the second switching element is determined on the basis of the average value of the reactor current. The duty ratio is outputted as a duty signal and is compared with the carrier signal. By this, the gate signal is generated. According to the apparatus for controlling the voltage converting apparatus of the present invention, the average value of the reactor current is accurately estimated, and it is thus possible to appropriately control the voltage converting apparatus.

In one aspect of the driving assistance apparatus of the present invention, the apparatus for controlling the voltage converting apparatus according to claim 1, wherein said average value estimating device has: a first current amount calculating device for calculating a first current amount flowing through the reactor in a first period, by using the first period, which is from rise timing of the gate signal in which the reactor current becomes zero to fall timing of the gate signal, and the reactor current in the fall timing; a zero timing calculating device for calculating timing in which the reactor current becomes zero, by using the reactor current in the fall timing and the reactor current immediately after the fall timing; a second current amount calculating device for calculating a second current amount flowing through the reactor in a second period, by using the second period, which is from the fall timing to the timing in which the reactor current becomes zero, and the reactor current in the fall timing; and an average value calculating device for calculating the average value of the reactor current, by using the first current amount, the second current amount, and one period of the gate signal.

According to this aspect, when the average value of the reactor current is estimated, firstly, the first current amount flowing through the reactor in the first period is calculated by the first current amount calculating device, by using the first period, which is from the rise timing of the gate signal in which the reactor current becomes zero to the fall timing of the gate signal, and the reactor current in the fall timing. The first current amount calculating device uses a length of the first period and the reactor current in the fall timing (in other words, a peak value of the reactor current) to calculate the first current amount. More specifically, the first current amount can be calculated as an area of a triangle having the length of the first period as a base thereof and the peak value of the reactor current as a height thereof.

Then, the timing in which the reactor current becomes zero is calculated by the zero timing calculating device. The zero timing calculating device uses the reactor current in the fall timing and the reactor current immediately after the fall timing to calculate a rate of change of the reactor current, thereby predicting the timing in which the reactor current becomes zero.

Incidentally, the expression “immediately after the fall timing” means timing after a lapse of a predetermined period from the fall timing, wherein the predetermine period is set to calculate the rate of change of the reactor current described above. The expression “immediately after the fall timing” is set, for example, as timing several microseconds after the fall timing. Incidentally, if the reactor current immediate after the fall timing has already reached zero, the rate of change of the reactor current cannot be accurately calculated. Thus, the predetermined period described above is preferably set as a relatively short period.

The rate of change of the current is a value indicating how the reactor current declines. Thus, using the value of the reactor current in the fall timing, the timing in which the reactor current becomes zero can be easily predicted.

If the timing in which the reactor current becomes zero is estimated, the second current amount flowing through the reactor in the second period is calculated by the second current amount calculating device, by using the second period, which is from the fall timing to the timing in which the reactor current becomes zero, and the reactor current in the fall timing. The second current amount calculating device uses a length of the second period and the reactor current in the fall timing to calculate the second current amount. More specifically, the second current amount can be calculated as an area of a triangle having the length of the second period as a base thereof and the peak value of the reactor current as a height thereof.

Incidentally, the first current amount and the second current amount can be calculated together or at a time as an area of a triangle having a period from the rise timing of the gate signal to the timing in which the reactor current becomes zero (i.e. the sum of the first period and the second period) as a base thereof and the reactor current in the fall timing as a height thereof.

If the first current amount and the second current amount are calculated, the average value of the reactor current is calculated by the average value calculating device. The average value calculating device uses the one period of the gate signal in addition to the first current amount and the second current amount, to calculate the average value of the reactor current. More specifically, the average value of the reactor current can be calculated as a value obtained by dividing a value which is obtained by summing the first current amount and the second current amount calculated as the area of the triangle as described above (i.e. a total current amount flowing in one period of the gate signal) by a length of one period of the gate signal (in other words, a height of a rectangle having the same area as that of the triangle corresponding to the total current amount and having one period of the gate signal as a length thereof).

By virtue of the aforementioned configuration, the average value of the reactor current can be calculated as an accurate value and easily, even in the case of the one-arm drive.

In one aspect of the driving assistance apparatus of the present invention, the apparatus for controlling the voltage converting apparatus according to claim 2, provide with: a second average value estimating device for estimating an intermediate value of the reactor current in the rise timing of the gate signal and the reactor current in the fall timing, as the average value of the reactor current; a current value predicting device for predicting a reactor current in next rise timing by using the reactor current in the fall timing and the reactor current immediately after the fall timing; and a changing device for changing which of said average value estimating device and said second average value estimating device is used, on the basis of the predicted reactor current.

In this case, in addition to the aforementioned average value estimating device (i.e. the device for estimating the average value of the reactor current by using the first current amount and the second current amount), there is provided the second average value estimating device for estimating the intermediate value of the reactor current in the rise timing of the gate signal and the reactor current in the fall timing, as the average value of the reactor current. Thus, when the average value of the reactor current is estimated, one of the estimating devices can be selected and used.

When the average value of the reactor current is estimated, firstly, the reactor current in the next rise timing is predicted by the current value predicting device, by using the reactor current in the fall timing and the reactor current immediately after the fall timing. In other words, the reactor current in the next rise timing is predicted in the method using the rate of change of the current, as in the zero timing calculating device described above. Incidentally, the “next rise timing” means rise timing immediately after the fall timing in which the reactor current is sampled.

If the reactor current in the next rise timing is predicted, the use of the average value estimating device and the second average value estimating device is changed by the changing device, on the basis of the predicted reactor current. Here, the average value estimating device can accurately estimate the average value of the reactor current even in the case of the one-arm drive as described above, but cannot be applied if the reactor current is not zero in the first rise timing of the gate signal. On the other hand, the second average value estimating device cannot accurately estimate the average value of the reactor current if the reactor current is zero, but can accurately estimate the average value of the reactor current if the reactor current is not zero.

As described above, the average value estimating device and the second average value estimating device have different applicable ranges from each other. Thus, if it is changed which estimating device is used on the basis of the reactor current in the rise timing of the gate signal, the appropriate estimating device according to conditions can be selected, and the average value of the reactor current can be estimated, more preferably.

The nature, utility, and further features of this invention will be more clearly apparent from the following detailed description with reference to a preferred embodiment of the invention when read in conjunction with the accompanying drawings briefly described below.

### BRIEF DESCRIPTION OF THE DRAWINGS

FIG. 1 is a schematic diagram illustrating an entire configuration of a vehicle equipped with an apparatus for controlling a voltage converting apparatus in a first embodiment;

FIG. 2 is a chart illustrating fluctuation of a current value at the time of two-arm drive:

FIG. 3 is a conceptual diagram illustrating a current flow at the time of lower-arm drive;

FIG. 4 is a conceptual diagram illustrating a current flow at the time of upper-arm drive;

FIG. 5 is a chart illustrating fluctuation of a current value at the time of one-arm drive;

FIG. 6 is a block diagram illustrating a configuration of an ECU in the first embodiment;

FIG. 7 is a block diagram illustrating a configuration of an average reactor current estimation circuit in the first embodiment;

FIG. 8 is a flowchart illustrating operation of the apparatus for controlling the voltage converting apparatus in the first embodiment;

FIG. 9 is a chart illustrating a method of estimating an average reactor current at the time of lower-arm drive;

FIG. 10 is a chart illustrating a method of estimating the average reactor current at the time of upper-arm drive;

FIG. 11 is a block diagram illustrating a configuration of an ECU in a second embodiment;

FIG. 12 is a flowchart illustrating operation of an apparatus for controlling the voltage converting apparatus in the second embodiment;

FIG. 13 is a chart illustrating a method of determining change of an estimating device at the time of lower-arm drive; and

FIG. 14 is a chart illustrating a method of determining change of the estimating device at the time of lower-arm drive.

### DETAILED DESCRIPTION OF THE PREFERRED EMBODIMENTS

Hereinafter, embodiments of the present invention will be explained with reference to the drawings.

### First Embodiment

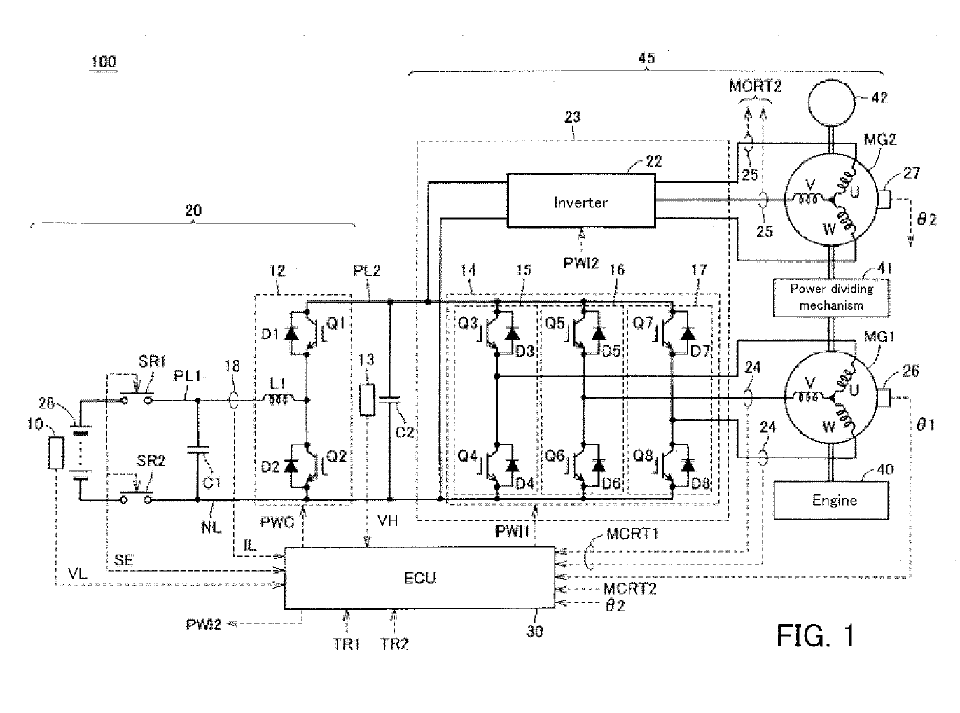

Firstly, an entire configuration of a vehicle equipped with an apparatus for controlling a voltage converting apparatus in a first embodiment will be explained with reference to FIG. 1. FIG. 1 is a schematic diagram illustrating the entire configuration of the vehicle equipped with the apparatus for controlling the voltage converting apparatus in the first embodiment.

In FIG. 1, a vehicle 100 equipped with the apparatus for controlling the voltage converting apparatus in the first embodiment is configured as a hybrid vehicle using an engine 40 and motor generators MG1 and MG2 as a power source. The configuration of the vehicle 100 is not limited to this example, and can be also applied to a vehicle which can drive due to electric power from an electrical storage device (e.g. an electric vehicle and a fuel-cell vehicle). Moreover, in the first embodiment, an explanation will be given to the configuration that the apparatus for controlling the voltage converting apparatus is mounted on the vehicle 100; however, the apparatus for controlling the voltage converting apparatus can be applied to any apparatus that is driven by an alternating current (AC) electric motor, other than the vehicle.

The vehicle 100 is provided with a direct current (DC) voltage generation unit 20, a load device 45, a smoothing condenser C2, and an ECU 30.

The DC voltage generation unit 20 includes an electrical storage device 28, system relays SR1 and SR2, a smoothing condenser C1, and a converter 12.

The electrical storage device 28 includes an electrical storage device, such as a secondary battery like, for example, nickel metal hydride or lithium ion, and an electrical double layer capacitor. Moreover, a DC voltage VL outputted by the electrical storage device 28 is detected by a voltage sensor 10. The voltage sensor 10 outputs a detected value of the DC voltage VL to the ECU 30.

The system relay SR1 is connected between a positive terminal of the electrical storage device 28 and a power line PL1. The system relay SR2 is connected between a negative terminal of the electrical storage device 28 and a grounding line NL. The system relays SR1 and SR2 are controlled by a signal SE from the ECU 30 to change supply and cutoff of the electric power to the converter 12 from the electrical storage device 28.

The converter 12 is one example of the “voltage converting apparatus” of the present invention. The converter 12 includes a reactor L1, switching elements Q1 and Q2, and diodes D1 and D2. The switching elements Q1 and Q2 are one example of the “first switching element” and the “second switching element” of the present invention, respectively, and are connected in series between a power line PL2 and the grounding line NL. The switching elements Q1 and Q2 are controlled by a gate signal PWC from the ECU 30.

For the switching elements Q1 and Q2, for example, an IGBT, a power MOS transistor, a power bipolar transistor, or the like can be used. For the switching elements Q1 and Q2, reverse parallel diodes D1 and D2 are provided, respectively. The reactor L1 is disposed between a connection node of the switching elements Q1 and Q2 and the power line PL1. Moreover, the smoothing condenser C2 is connected between the power line PL2 and the grounding line NL.

The current sensor 18 is one example of the “current detecting device” of the present invention. The current sensor 18 detects a reactor current flowing through the reactor L1 and outputs a detected value IL of the reactor current to the ECU 30.

The load device 45 includes an inverter 23, motor generators MG1 and MG2, an engine 40, a power dividing mechanism 41, and a driving wheel 42. The inverter 23 includes an inverter 14 for driving the motor generator MG1 and an inverter 22 for driving the motor generator MG2. Incidentally, it is not essential to provide two sets of the inverter and the motor generator as illustrated in FIG. 1. For example, either a set of the inverter 14 and the motor generator MG1 or a set of the inverter 22 and the motor generator MG2 may be provided.

The motor generators MG1 and MG2 generate a rotational driving force for propelling the vehicle in response to AC power supplied from the inverter 23. The motor generators MG1 and MG2 receive a rotational force from the exterior, generate AC power due to a regenerative torque command from the ECU 30, and generate a regenerative braking force in the vehicle 100.

The motor generators MG1 and MG2 are also connected to the engine 40 via the power dividing mechanism 41. A driving force generated by the engine 40 and the driving force generated by the motor generators MG1 and MG2 are controlled to have an optimal ratio. Moreover, one of the motor generators MG1 and MG2 may be set to function only as an electric motor, and the other motor generator may be set to function only as a generator. Incidentally, in the first embodiment, the motor generator MG1 is set to function as a generator driven by the engine 40, and the motor generator MG2 is set to function as an electric motor driven by the driving wheel 42.

The power dividing mechanism 41 uses, for example, a planetary gear mechanism (planetary gear) to divide the power of the engine 40 into the driving wheel 42 and the motor generator MG1.

The inverter 14 drives the motor generator MG1, for example, to start the engine 40 in response to an increased voltage from the converter 12. The inverter 14 also outputs, to the converter 12, regenerative electric power generated by the motor generator MG1 due to the mechanical power transmitted from the engine 40. At this time, the converter 12 is controlled by the ECU 30 to operate as a voltage lowering circuit or a voltage down converter.

The inverter 14 is provided in parallel between the power line PL2 and the grounding line NL, and includes a U-phase upper-lower arm 15, a V-phase upper-lower arm 16, and a W-phase upper-lower arm 17. Each phase upper-lower arm is provided with switching elements which are connected in series between the power line PL2 and the grounding line NL. For example, the U-phase upper-lower arm 15 is provided with switching elements Q3 and Q4. The V-phase upper-lower arm 16 is provided with switching elements Q5 and Q6. The W-phase upper-lower arm 17 is provided with switching elements Q7 and Q8. Moreover, to the switching elements Q3 to Q8, reverse parallel diodes D3 to D8 are connected, respectively. The switching elements Q3 to Q8 are controlled by a gate signal PWI from the ECU 30.

For example, the motor generator MG1 is a three-phase permanent magnet synchronous motor, and one ends of three coils in the U, V, and W phases are commonly connected to a neutral point of the motor generator MG1. Moreover, the other ends of the respective phase coils are connected to connection nodes of the respective phase upper-lower arms 15 to 17.

The inverter 22 is connected in parallel with the inverter 14 with respect to the converter 12.

The inverter 22 converts a DC voltage outputted by the converter 12 to a three-phase AC voltage and outputs it to the motor generator MG2 for driving the driving wheel 42. Moreover, the inverter 22 outputs regenerative electric power generated by the motor generator MG2 to the converter 12, in association with regenerative braking. At this time, the converter 12 is controlled by the ECU 30 to function as a voltage lowering circuit or a voltage down converter. An internal configuration of the inverter 22 is not illustrated, but is the same as that of the inverter 14, and a detailed explanation thereof will be omitted.

The converter 12 is controlled basically such that the switching elements Q1 and Q2 are switched on and off, complementarily and alternately, within each switching period. The converter 12 increases the DC voltage VL supplied from the electrical storage device 28, to a DC voltage VH (wherein this DC voltage corresponding to an input voltage to the inverter 14 will be also hereinafter referred to as a “system voltage”) in a boosting or voltage increasing operation. The voltage increasing operation is performed by supplying electromagnetic energy stored in the reactor L1 during an ON period of the switching element Q2, to the power line PL2 via the switching element Q1 and the reverse parallel diode D1.

Moreover, the converter 12 lowers the DC voltage VH to the DC voltage VL in a voltage lowering operation. The voltage lowering operation is performed by supplying electromagnetic energy stored in the reactor L1 during an ON period of the switching element Q1, to the grounding line NL via the switching element Q2 and the reverse parallel diode D2.

A voltage conversion ratio (a ratio of VH and VL) in the voltage increasing operation and the voltage lowering operation is controlled by an ON period ratio (a duty ratio) of the switching elements Q1 and Q2 in the switching period. Incidentally, if the switching element Q1 is fixed to be ON and the switching element Q2 is fixed to be OFF, it is also possible to set VH=VL (voltage conversion ratio=1.0).

The smoothing condenser C2 smoothes the DC voltage from the converter 12, and supplies the smoothed DC voltage to the inverter 23. A voltage sensor 13 detects a voltage between both ends of the smoothing condenser C2, i.e. the system voltage VH, and outputs a detected value of the system voltage VH to the ECU 30.

In cases where a torque command of the motor generator MG1 is positive (TR1>0), when the DC voltage is supplied from the smoothing condenser C2, the inverter 14 drives the motor generator MG1 to convert the DC voltage to an AC voltage and to output positive torque by a switching operation of the switching elements Q3 to Q8 responding to a gate signal PWI1 from the ECU 30. In cases where the torque command of the motor generator MG1 is zero (TR1=0), the inverter 14 drives the motor generator MG1 to convert the DC voltage to the AC voltage and to provide zero torque by the switching operation responding to the gate signal PWI1. By this, the motor generator MG1 is driven to generate zero or positive torque specified by the torque command TR1.

Moreover, upon regenerative braking of the vehicle 100, the torque command TR1 of the motor generator MG1 is set to be negative (TR1<0). In this case, the inverter 14 converts the AC voltage generated by the motor generator MG1 to a DC voltage by the switching operation responding to the gate signal PWI1, and supplies the converted DC voltage (system voltage) to the converter 12 via the smoothing condenser C2. Incidentally, the regenerative braking herein includes braking associated with power regeneration when a foot brake operation is performed by a driver who drives an electrically-driven vehicle, and deceleration (or stopping acceleration) of a vehicle during the power regeneration by stepping off an accelerator pedal in travelling even though a foot brake is not operated.

In the same manner, the inverter 22 drives the motor generator MG2 to convert the DC voltage to the AC voltage and to provide predetermined torque by the switching operation responding to a gate signal PWI2 from the ECU 30 corresponding to a torque command of the motor generator MG2.

Current sensors 24 and 25 detect motor currents MCRT1 and MCRT2 flowing through the motor generators MG1 and MG2, respectively, and output the detected motor currents to the ECU 30. Incidentally, the sum of instantaneous values in the U-phase, the V-phase, and the W-phase is zero, and it is thus sufficient to arrange the current sensors 24 and 25 to detect the motor currents in the two phases, as illustrated in FIG. 1.

Rotational angle sensors (resolvers) 26 and 27 detect a rotational angle θ1 of the motor generator MG1 and a rotational angle θ2 of the motor generator MG2, respectively, and transmit the detected rotational angles θ1 and θ2 to the ECU 30. The ECU 30 can calculate rotational speeds MRN1 and MRN2 and angular velocities ω1 and ω2 (rad/s) of the motor generators MG1 and MG2 on the basis of the rotational angles θ1 and θ2, respectively. Incidentally, the rotational angle sensors 26 and 27 may not be provided by directly operating or calculating the rotational angles θ1 and θ2 from a motor voltage and an electric current on the ECU 30.

The ECU 30 is one example of the “apparatus for controlling the voltage converting apparatus” of the present invention. The ECU 30 includes, for example, a central processing unit (CPU), a storage device, and an input/output buffer, and controls each device of the vehicle 100. Incidentally, control performed by the ECU 30 is not limited to processing using software. Dedicated hardware (electronic circuit) can be also established to perform processing.

As a representative function, the ECU 30 controls the operation of the converter 12 and the inverter 23 such that the motor generators MG1 and MG2 output torque according to the torque commands TR1 and TR2, on the basis of the inputted torque commands TR1 and TR2, the DC voltage VL detected by the voltage sensor 10, the system voltage VH detected by the voltage sensor 13, the motor currents MCRT1 and MCRT2 from the current sensors 24 and 25, the rotational angles θ1 and θ2 from the rotational angle sensors 26 and 27, and the like. In other words, the ECU 30 generates the gate signals PWC, PWI1, and PWI2 to control the converter 12 and the inverter 23 as described above, and outputs each of the gate signals to respective one of the converter 12 and the inverter 23.

In the voltage increasing operation of the converter 12, the ECU 30 feedback-controls the system voltage VH and generates the gate signal PWC to match the system voltage VH with a voltage command.

Moreover, when the vehicle 100 becomes into a regenerative braking mode, the ECU 30 generates the gate signals PWI1 and PWI2 to convert the AC voltage generated by the motor generators MG1 and MG2 to the DC voltage, and outputs the gate signals to the inverter 23. By this, the inverter 23 converts the AC voltage generated by the motor generators MG1 and MG2 to the DC voltage and supplies it to the converter 12.

Moreover, when the vehicle 100 becomes into the regenerative braking mode, the ECU 30 generates the gate signal PWC to lower the DC voltage supplied from the inverter 23 and outputs it to the converter 12. By this, the AC voltage generated by the motor generators MG1 and MG2 is converted to the DC voltage, is lowered, and is supplied to the electrical storage device 28.

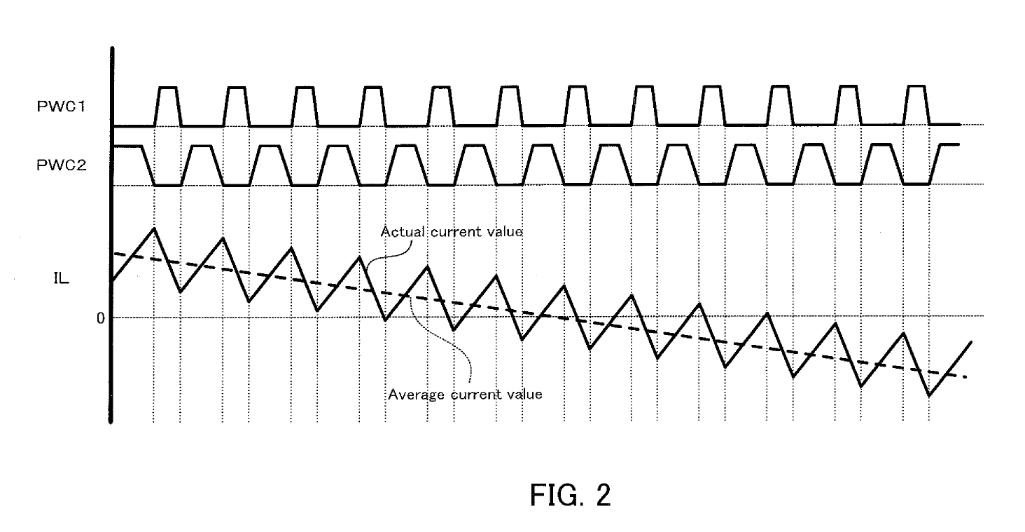

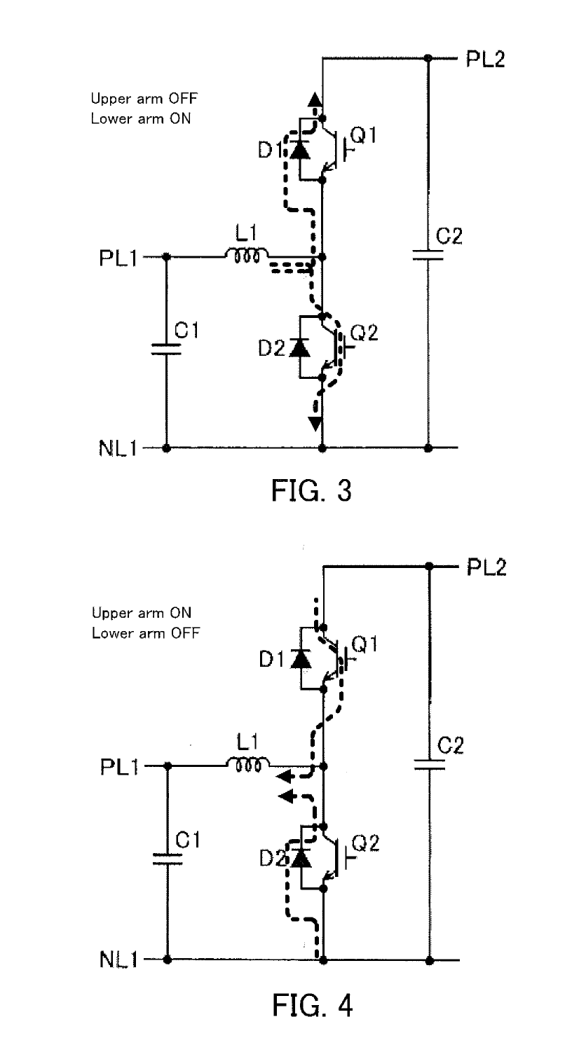

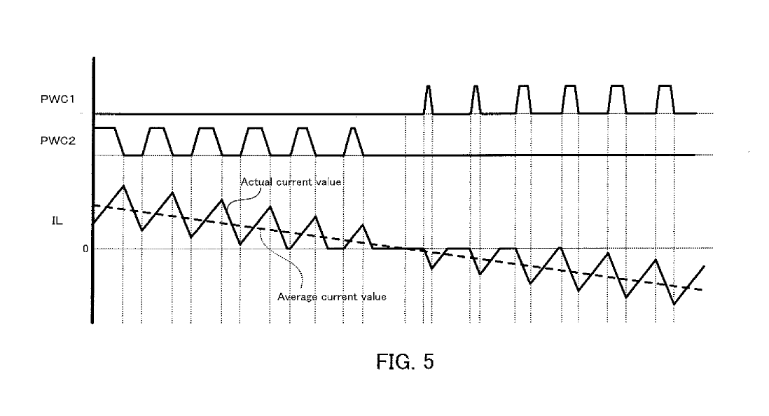

Now, current fluctuation in the operation of the converter 12 will be explained with reference to FIG. 2 to FIG. 5. FIG. 2 is a chart illustrating fluctuation of a current value at the time of two-arm drive. FIG. 3 is a conceptual diagram illustrating a current flow at the time of lower-arm drive. FIG. 4 is a conceptual diagram illustrating a current flow at the time of upper-arm drive. FIG. 5 is a chart illustrating fluctuation of a current value at the time of one-arm drive.

In FIG. 2, if the converter 12 performs two-arm drive (i.e. drive for switching on both the switching elements Q1 and Q2), a gate signal PWC1 for changing the on and off of the switching element Q1 and a gate signal PWC2 for changing the on and off of the switching element Q2 are supplied to the switching elements Q1 and Q2, respectively, by which the value of the reactor current IL is controlled.

Incidentally, at the time of two-arm drive, a positive current and a negative current can be applied by each of the switching elements Q1 and Q2. Thus, for example, even in current control in which the reactor current crosses zero as illustrated, the same control as normal can be performed.

In FIG. 3 and FIG. 4, the converter 12 in the first embodiment can realize one-arm drive for switching on only one of the switching elements Q1 and Q2, in addition to the two-arm drive described above. Specifically, upon power running, the lower-arm drive for switching on only the switching element Q2 is performed. In this case, as illustrated in FIG. 3, an electric current flowing on the switching element Q1 side flows via the diode D1, and an electric current flowing on the switching element Q2 flows via the switching element Q2. On the other hand, upon regeneration, the upper-arm drive for switching on only the switching element Q1 is performed. In this case, as illustrated in FIG. 4, an electric current flowing on the switching element Q1 side flows via the switching element Q1, and an electric current flowing on the switching element Q2 flows via the diode D2.

According to the one-arm drive, only one of the switching elements Q1 and Q2 is switched on, and thus, a dead time set to prevent a short circuit of the switching elements is not required. Thus, for example, even if high frequency is required in association with a miniaturized apparatus, it is possible to prevent a reduction in boosting performance of the converter 12.

In FIG. 5, upon power running in which the lower-arm drive is performed (i.e. in cases where the reactor current IL is positive), the gate signal PWC1 for changing the on and off of the switching elements Q1 is not supplied, and only the gate signal PWC 2 for changing the on and off of the switching elements Q2 is supplied. Moreover, upon regeneration in which the upper-arm drive is performed (i.e. in cases where the reactor current IL is negative), only the gate signal PWC1 for changing the on and off of the switching elements Q1 is supplied, and the gate signal PWC 2 for changing the on and off of the switching elements Q2 is not supplied.

In particular, since the negative current cannot be applied at the time of lower-arm drive, if a lower limit of the reactor current IL falls to zero, it is required to change the duty ratio of the gate signal PWC2 to perform non-linear control. In the same manner, since the positive current cannot be applied at the time of upper-arm drive, if an upper limit of the reactor current IL falls to zero, it is required to change the duty ratio of the gate signal PWC1 to perform non-linear control. In other words, at the time of one-arm drive, if the reactor current IL approaches zero, relatively complicated control which is different from the normal control is required.

The apparatus for controlling the voltage converting apparatus in the first embodiment aims at accurately estimating an average value of the reactor current IL near zero at the time of one-arm drive described above.

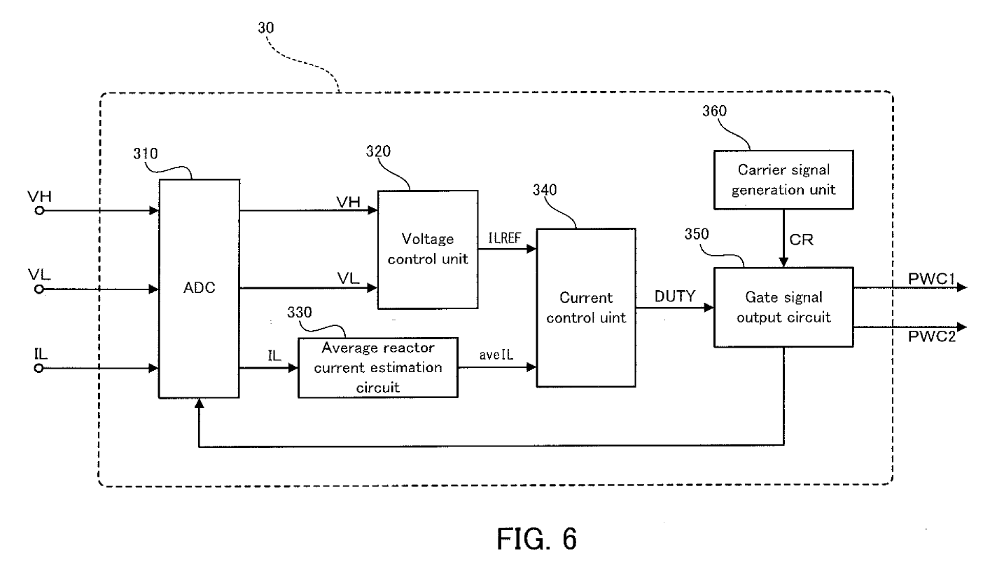

Next, with reference to FIG. 6, an explanation will be given to a specific configuration of the ECU 30 which is the apparatus for controlling the voltage converting apparatus in the first embodiment. FIG. 6 is a block diagram illustrating the configuration of the ECU in the first embodiment. Incidentally, for convenience of explanation, FIG. 6 illustrates only parts deeply related to the first embodiment, out of parts provided for the ECU 30, and the illustration of the other detailed parts is omitted.

In FIG. 6, the ECU 30 is provided with an analog to digital converter (ADC) 310, a voltage control unit 320, an average reactor current estimation circuit 330, a current control unit 340, a gate signal output circuit 350, and a carrier signal output unit 360.

The ADC 310 is one example of the “current detecting device” of the present invention. The ADC 310 samples a value of the reactor current IL at a plurality of times and outputs it to the average reactor current estimation circuit 330. The ADC 310 samples each of the input voltage VL (a voltage value before the boost detected by the voltage sensor 10) and the output voltage VH (a voltage value after the boost detected by the voltage sensor 13) and outputs each of the voltages to the voltage control unit 320. Incidentally, the sampling timing on the ADC 310 is determined on the basis of a signal indicating an active switching element inputted from the gate signal output circuit 350. The specific sampling timing on the ADC 310 will be detailed later.

The voltage control unit 320 arithmetically operates a voltage deviation on the basis of the output voltage VH and the input voltage VL sampled on the ADC 310, and calculates a reactor current command ILREF. The calculated reactor current command ILREF is outputted to the current control unit 340.

The average reactor current estimation circuit 330 is one example of the “average value estimating device” of the present invention, and estimates an average value aveIL of the reactor current IL. The average value aveIL of the is reactor current IL estimated on the average reactor current estimation circuit 330 is outputted to the current control unit 340 and is used for feedback-control. A specific method of estimating the average value aveIL, of the reactor current IL will be detailed later.

The current control unit 340 arithmetically operates a current deviation on the basis of the reactor current command ILREF inputted from the voltage control unit 320 and the estimated reactor current aveIL, and calculates a duty command signal DUTY of the switching elements Q1 and Q2. The calculated duty command signal DUTY is outputted to the gate signal output circuit 350.

The gate signal output circuit 350 is one example of the “controlling device” of the present invention. The gate signal output circuit 350 generates PWC1 and PWC2 which are the gate signals of the switching elements Q1 and Q2, on the basis of the duty command signal DUTY inputted from the current control unit 340 and a carrier signal CR generated on the carrier signal generation unit 360.

The carrier signal generation unit 360 generates the carrier signal CR of a predetermined period in order to generate the gate signals PWC1 and PWC2. The carrier signal CR is outputted to the gate signal output circuit 350.

The ECU 30 explained above is an integral or unified electronic control unit including each of the parts described above, and all the operations of the respective parts are performed by the ECU 30. However, physical, mechanical, and electrical configurations of the parts in the present invention are not limited to this example. For example, each of the parts or devices may be configured as various computer systems, such as microcomputer apparatuses, various controllers, various processing units, and a plurality of ECUs.

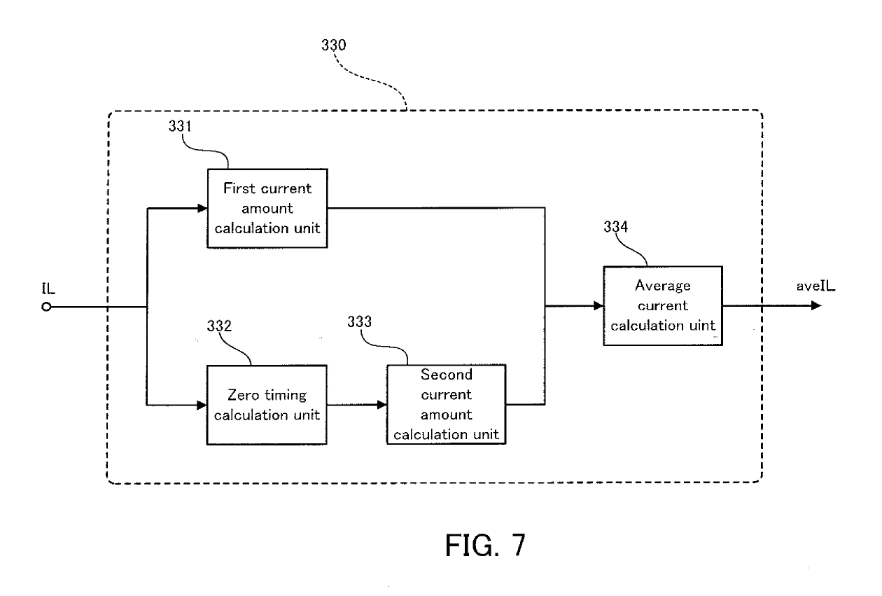

Next, with reference to FIG. 7, an explanation will be given to a specific configuration of the average reactor current estimation circuit 330 included in the ECU 30 described above. FIG. 7 is a block diagram illustrating the configuration of the average reactor current estimation circuit in the first embodiment.

In FIG. 7, the average reactor current estimation circuit 330 is provided with a first current amount calculation unit 331, a zero timing calculation unit 332, a second current amount calculation unit 333, and an average current calculation unit 334.

The first current amount calculation unit 331 is one example of the “first current amount calculating device” of the present invention. The first current amount calculation unit 331 calculates a first current amount flowing through the reactor L1 in a first period from rise timing to fall timing of the gate signal PWC, wherein the reactor current IL becomes zero in the rise timing. The first current amount calculation unit 331 uses a length of the first period and the reactor current in the fall timing of the gate signal PWC (a peak value of the reactor current) to calculate the first current amount.

The zero timing calculation unit 332 is one example of the “zero timing calculating device” of the present invention. The zero timing calculation unit 332 calculates timing in which the reactor current IL becomes zero after the rise timing of the gate signal PWC. The zero timing calculation unit 332 uses the reactor current in the fall timing of the gate signal PWC and the reactor current immediately after the fall timing to calculate a rate of change of the reactor current, thereby predicting the timing in which the reactor current IL becomes zero.

The second current amount calculation unit 333 is one example of the “second current amount calculating device” of the present invention. The second current amount calculation unit 333 calculates a second current amount flowing through the reactor L1 in a second period from the fall timing of the gate signal PWC to the timing in which the reactor current IL becomes zero. The second current amount calculation unit 333 uses a length of the second period and the reactor current in the fall timing of the gate signal PWC to calculate the second current amount.

The average current calculation unit 334 is one example of the “average value calculating device” of the present invention. The average current calculation unit 334 uses the first current amount and the second current amount to calculate the average value aveIL of the reactor current IL. The average current calculation unit calculates the average value aveIL of the reactor current IL, as a value obtained by dividing a value which is obtained by summing the first current amount and the second current amount (i.e. a total current amount flowing in one period of the gate signal) by a length of one period of the gate signal.

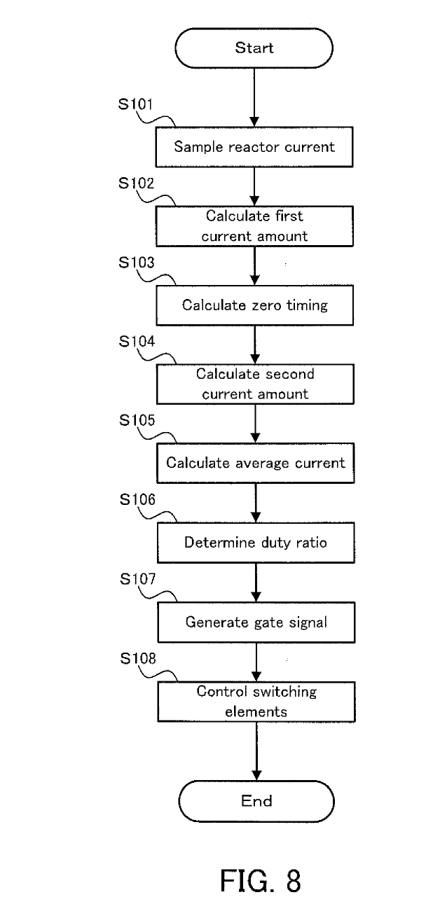

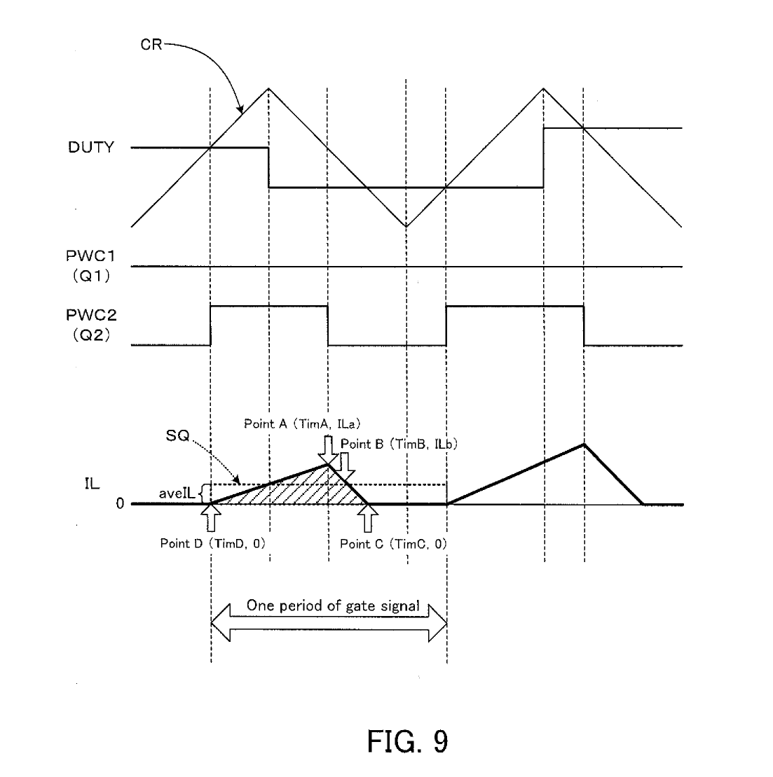

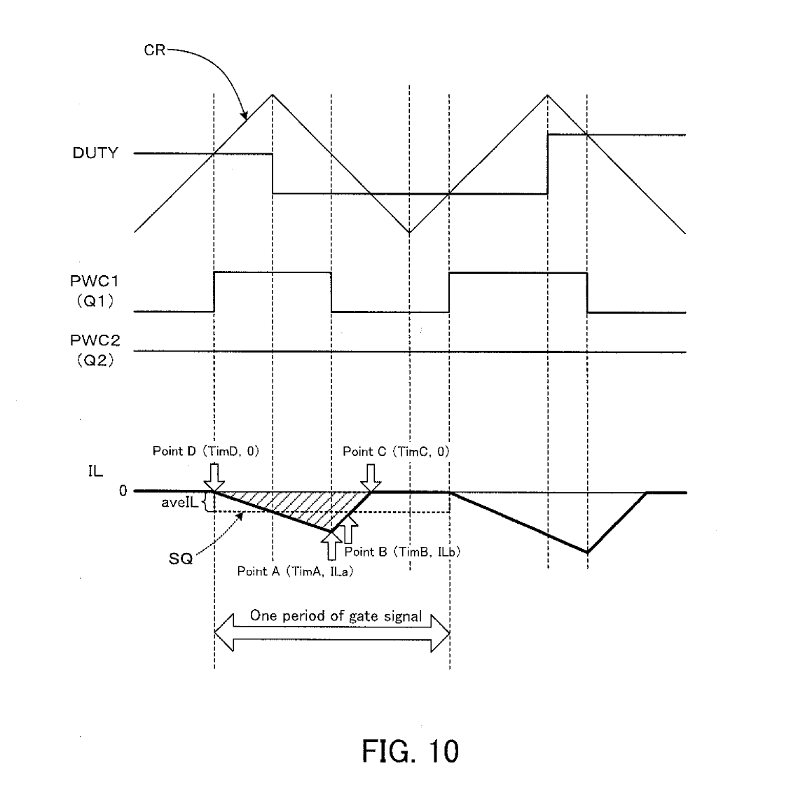

Next, operation of the apparatus for controlling the voltage converting apparatus in the first embodiment will be explained with reference to FIG. 8 to FIG. 10. FIG. 8 is a flowchart illustrating the operation of the apparatus for controlling the voltage converting apparatus in the first embodiment. FIG. 9 is a chart illustrating a method of estimating the average reactor current at the time of lower-arm drive. FIG. 10 is a chart illustrating a method of estimating the average reactor current at the time of upper-arm drive. Incidentally, hereinafter, processing associated with the calculation of the average reactor current peculiar to the first embodiment will be explained in detail, and an explanation of the other general processing will be omitted as occasion demands.

In FIG. 8 and FIG. 9, in operation of the apparatus for controlling the voltage converting apparatus in the first embodiment, firstly, the reactor current IL is sampled in predetermined timing by the ADC 310 (step S101). Specifically, the reactor current IL is sampled at each of a point A, which is the fall timing of the gate signal PWC2, and a point B immediately after (e.g. several microseconds after) the point A (refer to FIG. 9).

Then, a first current amount W1 is calculated by the first current amount calculation unit 331 (step S102). The first current amount W1 corresponds to an area of a triangle on a left side viewed from the point A (i.e. a triangle having a period from a point D to the point A as a base thereof and a reactor current ILa at the point A as a height thereof) out of a triangle ACD formed by the reactor current IL in FIG. 9. Thus, the first current amount W1 can be calculated using the following equation (1).

W1=(TimA−TimD)×ILa/2 (1)

Incidentally, “TimA” in the equation described above is a time point at the point A (i.e. the fall timing of the gate signal PWC2), and “TimD” is a time point at the point D (i.e. the rise timing of the gate signal PWC2).

Then, the timing in which the reactor current IL becomes zero after the fall timing of the gate signal PWC2 (i.e. a time point TimC at a point C in the drawing) is calculated by the zero timing calculation unit 332 (step S103). When the time point TimC at the point C is calculated, firstly, a rate of change di/dt of the rector current IL after the fall timing of the gate signal PWC2 is calculated. The rate of change di/dt of the rector current IL can be calculated by the following equation (2) using the time point TimA and the current value ILa at the point A, and a time point TimB and a current value ILb at the time point B.

di/dt=(ILb−ILa)/(TimB−TimA) (2)

If the rate of change di/dt of the reactor current IL is calculated, it becomes clear how the reactor current IL declines from the point A, by which the time point TimC at the point C can be calculated. The time point TimC at the point C can be calculated using the following equation (3).

TimC=−ILa/di/dt+TimA (3)

If TimC is calculated, a second current amount W2 is calculated by the second current amount calculation unit 333 (step S104). The second current amount W2 corresponds to an area of a triangle on a right side viewed from the point A (i.e. a triangle having a period from the point A to the point C as a base thereof and the reactor current ILa at the point A as a height thereof) out of the triangle ACD formed by the reactor current IL in FIG. 9. Thus, the second current amount W2 can be calculated using the following equation (4).

W2=(TimC−TimA)×ILa/2 (4)

If the first current amount W1 and the second current amount W2 are calculated, the average value aveIL of the reactor current IL in one period of the gate signal PWC2 is calculated by the average current calculation unit 334 (step S105). When the average value aveIL of the reactor current IL is calculated, firstly, a total current amount Wa of the reactor current IL flowing in one period of the gate signal PWC2 is calculated. Here, the total current amount Wa corresponds to an area of the triangle ACD in FIG. 9. Thus, the total current amount Wa is expressed by the following equation (5) using the first current amount W1 and the second current amount W2.

Wa=W1+W2 (5)

Incidentally, the total current amount Wa is not necessarily separately calculated as the first current amount W1 and the second current amount W2 as described above, but can be calculated together or at a time. Specifically, the total current amount Wa can be calculated as an area of a triangle having a period from the point D to the point C as a base thereof and the reactor current ILa at the point A as a height thereof. Thus, the total current amount Wa can be also calculated using the following equation (6).

Wa=(TimC−TimD)×ILa/2 (6)

The average value aveIL of the reactor current IL can be calculated as a height of a rectangle SQ having a length of one period of the gate signal PWC2 and the same area as that of the triangle ACD, as illustrated in FIG. 9. Now, since the area of the triangle ACD is the total current amount Wa, aveIL can be calculated using the following equation (7) if the length of one period of the gate signal PWC2 is Tpwc2.

aveIL=Wa/Tpwc2 (7)

As described above, in the apparatus for controlling the voltage converting apparatus in the first embodiment, the average value aveIL of the reactor current IL is calculated in units of periods of the gate signal PWC. Incidentally, as the method of estimating the average value aveIL of the reactor current IL, for example, there is a possible method of sampling the reactor current on the basis of the carrier signal CR to perform calculation. However, if the one-arm drive is performed, an electric current can be applied only in one polarity as long as the arm is not changed. Thus, there may be a situation in which a correspondence between the carrier signal CR and the reactor current IL is different from the case of normal drive (i.e. drive which is not the one-arm drive). For example, in the one-arm drive, the non-linear control is performed if the reactor current IL is near zero, and thus, periodic fluctuation of the reactor current IL is temporarily disrupted. Thus, even if the average value aveIL is calculated on the basis of the carrier signal CR, the calculated average value is unlikely an accurate value if the one-arm drive is performed.

In contrast, in the first embodiment, as described above, the average value aveIL of the reactor current IL is estimated in units of periods of the gate signal PWC. Here, regarding the period of the gate signal PWC, a correspondence thereof with the reactor current IL does not fall even in the one-arm drive, unlike the carrier signal CR. More specifically, the reactor current IL starts to increase in the rise timing of the gate signal PWC, and starts to decline in the fall timing of the gate signal PWC. Therefore, if the average value aveIL is calculated in units of periods of the gate signal PWC, it is possible to estimate an accurate value even in the case of the one-arm drive.

Incidentally, the aforementioned example explains the case where the lower-arm drive is performed (i.e. a case where the switching element Q1 is always off and the on and off the switching element Q2 is changed to perform the drive). Even in the case where the upper-arm drive is performed (i.e. a case where the switching element Q2 is always off and the on and off the switching element Q1 is changed to perform the drive), the average value aveIL of the reactor current IL can be estimated in the same manner.

Specifically, as illustrated in FIG. 9, the polarity of the reactor current IL is reversed between the case of the lower-arm drive and the case of the upper-arm drive. Even in this case, the average value aveIL of the reactor current IL can be estimated by obtaining the height of the rectangle SQ having the same area as that of the triangle ADC.

Back in FIG. 8, if the average value aveIL of the reactor current IL is estimated, the duty ratio of the switching elements Q1 and Q2 is determined on the current control unit 340 (step S106). The determined duty ratio is outputted to the gate signal output circuit 350 as the duty command signal DUTY.

On the gate signal output circuit 350, the gate signal PWC is generated by comparing the duty command signal DUTY and the carrier signal (step S107). Then, using the gate signal PWC, the switching of the switching elements Q1 and Q2 is controlled (step S108).

As explained above, the estimated average value aveIL of the reactor current IL is used to control the converter 12. According to the apparatus for controlling the voltage converting apparatus in the first embodiment, as described above, the average value aveIL of the reactor current IL can be accurately estimated even in the case of the one-arm drive, and it is thus possible to preferably control the converter 12.

### Second Embodiment

Next, an apparatus for controlling the voltage converting apparatus in a second embodiment will be explained. Incidentally, the second embodiment is different from the first embodiment described above only in a partial configuration and operation, and the other portions are almost the same. Thus, hereinafter, the different portion from the first embodiment will be explained in detail, and an explanation of the overlap portion will be omitted as occasion demands.

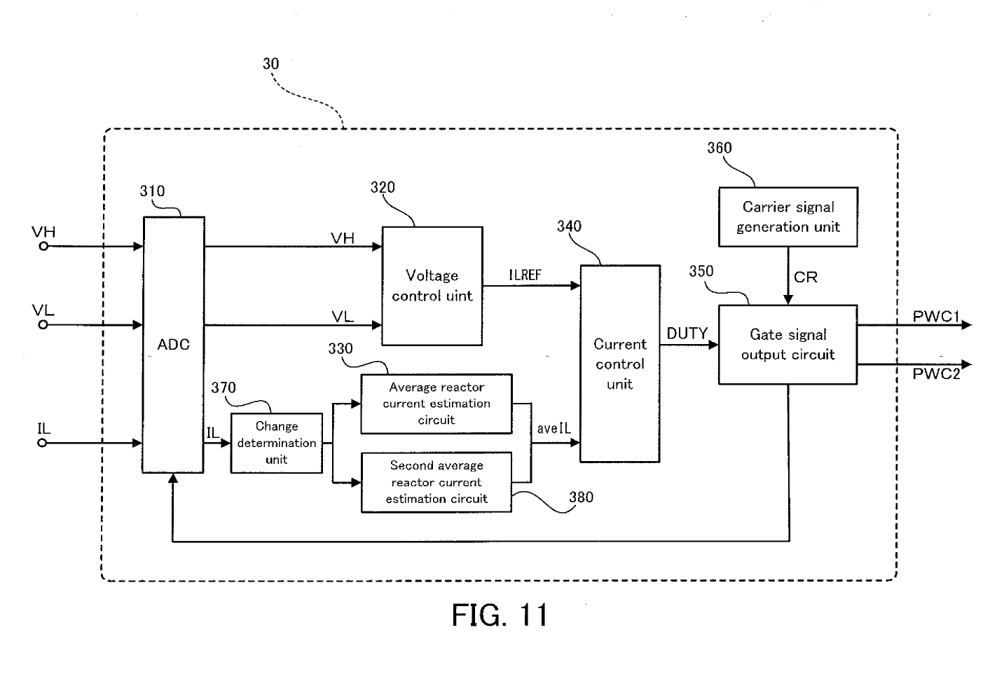

Firstly, a configuration of an ECU 30 which is the apparatus for controlling the voltage converting apparatus in the second embodiment will be explained with reference to FIG. 11. FIG. 11 is a block diagram illustrating the configuration of the ECU in the second embodiment.

In FIG. 11, the ECU 30 in the second embodiment is provided with a change determination unit 370 and a second average reactor current estimation circuit 380 in addition to each of the constituents of the ECU 30 in the first embodiment.

The change determination unit 370 is one example of the “current value predicting device” and the “changing device” of the present invention. The change determination unit 370 changes the use of the average reactor current estimation circuit 330 and the second average reactor current estimation circuit 380 when the average value aveIL of the reactor current IL is estimated. The change determination unit 370 changes the average reactor current estimation circuit 330 and the second average reactor current estimation circuit 380 depending on whether or not the reactor current IL in the rise timing of the gate signal PWC is greater than or equal to a predetermined threshold value, and selectively calculates the average value of the reactor current.

The second average reactor current estimation circuit 380 is one example of the “second average value estimating device” of the present invention. The second average reactor current estimation circuit 380 estimates the average value aveIL of the reactor current IL in a different method from that of the average reactor current estimation circuit 330. The second average reactor current estimation circuit 380 estimates, for example, an intermediate value of the reactor current in the fall timing of the gate signal PWC (in other words, a maximum value of the reactor current IL in one period of the gate signal PWC) and the reactor current in the rise timing of the gate signal PWC (in other words, a minimum value of the reactor current IL in one period of the gate signal PWC), as the average value aveIL of the reactor current IL.

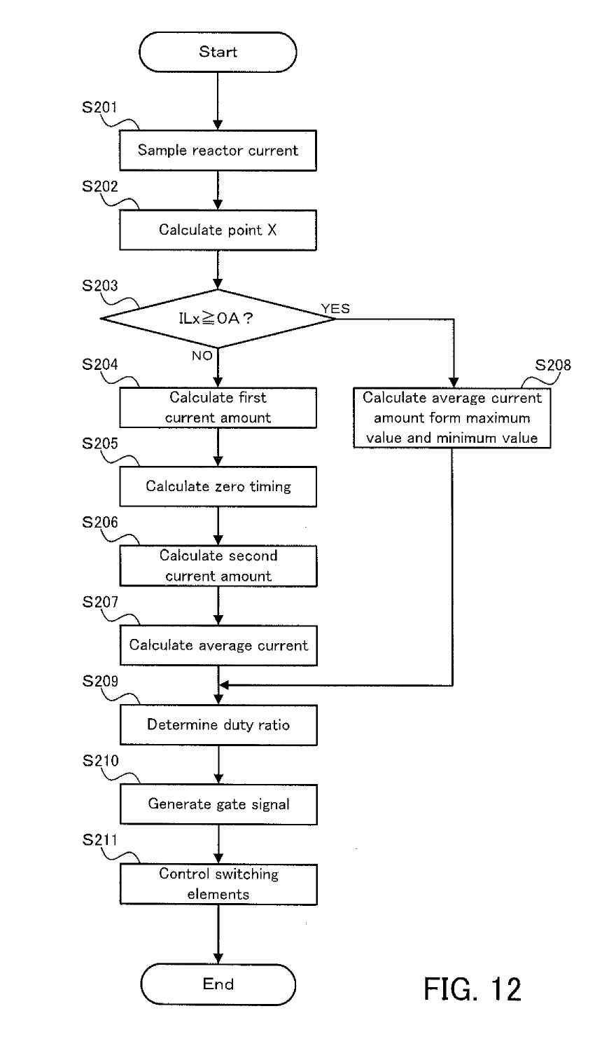

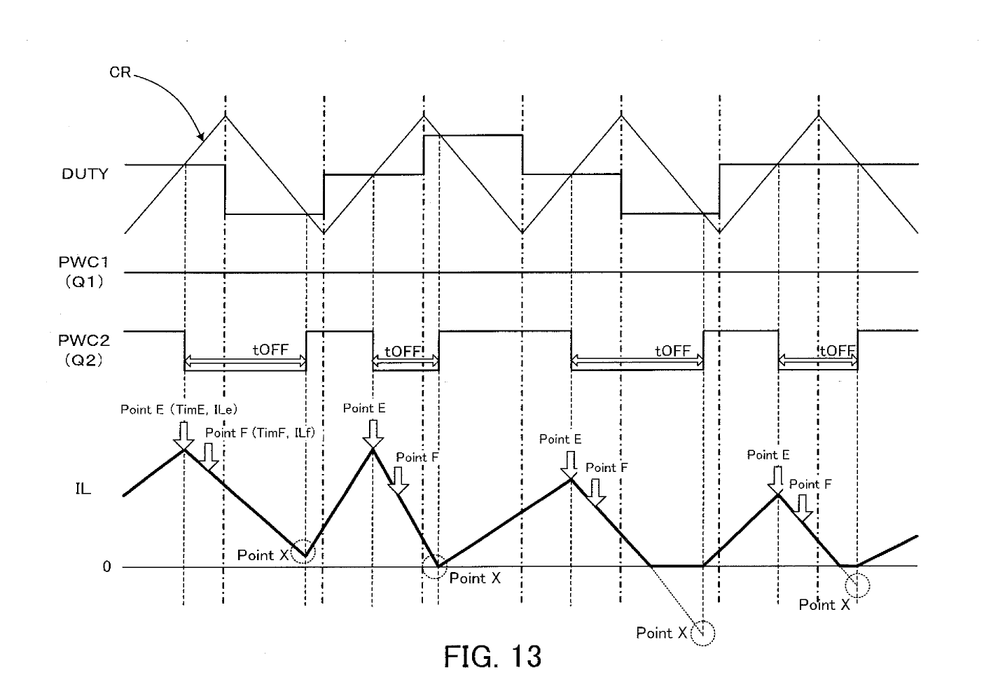

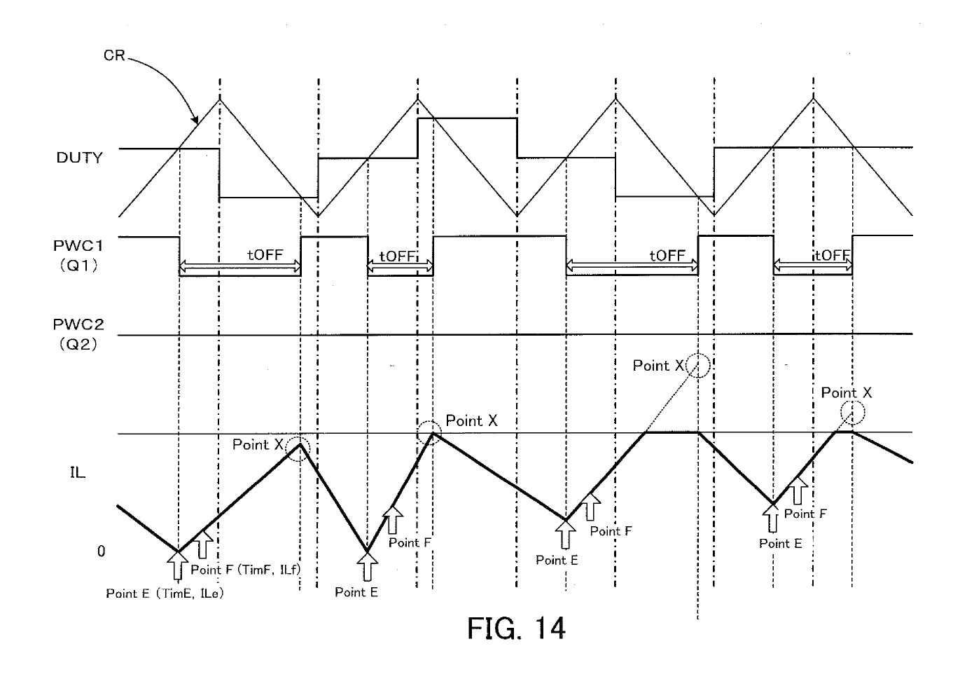

Next, the operation of the apparatus for controlling the voltage converting apparatus in the second embodiment will be explained with reference to FIG. 12 to FIG. 14. FIG. 12 is a flowchart illustrating the operation of the apparatus for controlling the voltage converting apparatus in the second embodiment. FIG. 13 is a chart illustrating a method of determining the change of the estimating device at the time of lower-arm drive. FIG. 14 is a chart illustrating a method of determining the change of the estimating device at the time of upper-arm drive.

In FIG. 12 and FIG. 13, in operation of the apparatus for controlling the voltage converting apparatus in the second embodiment, firstly, the reactor current IL is sampled in predetermined timing by the ADC 310 (step S201). Specifically, the reactor current IL is sampled at each of a point E, which is the fall timing of the gate signal PWC2, and a point F immediately after (e.g. several microseconds after) the point E (refer to FIG. 13).

Incidentally, the point E and the point F herein are set as the sampling timing for calculating the rate of change of the reactor current as described later, and corresponds to the point A and the point B in the first embodiment, respectively. Sampled reactor currents ILe and ILf are outputted to the change determination unit 370.

Then, the minimum value of the reactor current IL in one period of the gate signal PWC2 (in other words, the value of the reactor current in the rise timing of the gate signal PWC2) is estimated by the change determination unit 370 (step S202). The minimum value of the reactor current IL estimated by the change determination unit 370 is a value represented by a point X in FIG. 13. As is clear from the drawing, the estimated value herein is not a value of the actual electric current, but is a current value under the assumption that the electric current can change as if it crossed zero.

When the current value at the point X is calculated, firstly, the rate of change di/dt of the reactor current IL after the fall timing of the gate signal PWC2 is calculated. The rate of change di/dt of the reactor current IL can be calculated by the following equation (8) using a time point TimE and the current value ILe at the time point E, and a time point TimF and the current value ILf at the time point F.

di/dt=(ILf−ILe)/(TimF−TimE) (8)

If the rate of change di/dt of the reactor current IL is calculated, it becomes clear how the reactor current IL declines from the point E, by which a current value ILx at the point X can be calculated. The current value ILx at the point X can be calculated using the following equation (9) if an OFF period of the switching element Q2 (i.e. a period in which the reactor current keeps declining) is tOFF.

ILx=ILa+di/dt×tOFF (9)

If ILx is calculated, it is determined whether or not ILx is greater than or equal to zero, on the change determination unit 370 (step S203). If it is determined that ILx is not greater than or equal to zero (the step S203: NO), the average reactor current estimation circuit 330 is selected as the device of estimating the average value aveIL of the reactor current IL, and the average value aveIL of the reactor current IL is estimated in the same method as in the first embodiment described above (steps S204 to S207). On the other hand, if it is determined that ILx is greater than or equal to zero (the step S203: YES), the second average reactor current estimation circuit 380 is selected as the device of estimating the average value aveIL of the reactor current IL, and the intermediate value of the maximum value and the minimum value of the reactor current IL in one period of the gate signal PWC is estimated as the average value aveIL of the reactor current IL (step S208).

The average value aveIL of the reactor current IL estimated by the average reactor current estimation circuit 330 or the second average reactor current estimation circuit 380 is used for switching control of the switching elements Q1 and Q2, as in the first embodiment (steps S209 to S211).

Here, the average reactor current estimation circuit 330 can accurately estimate the average value aveIL of the reactor current IL even in the case of the one-arm drive as described above, but cannot be applied if the reactor current is not zero in the rise timing of the gate signal PWC2. On the other hand, the second average reactor current estimation circuit 380 cannot accurately estimate the average value aveIL of the reactor current IL if the reactor current IL is zero, but can accurately estimate the average value aveIL of the reactor current IL if the reactor current is not zero.

As described above, the average reactor current estimation circuit 330 and the second average reactor current estimation circuit 380 have different applicable ranges from each other. Thus, if it is changed which estimating device is used on the basis of the reactor current IL in the rise timing of the gate signal PWC2, the appropriate estimating device according to conditions can be selected, and the average value aveIL of the reactor current IL can be estimated, more preferably.

Incidentally, the aforementioned example explains the case of the lower-arm drive. Even in the case of the upper-arm drive, the estimating device can be changed in the same manner.

Specifically, as illustrated in FIG. 14, the polarity of the reactor current IL is reversed between the case of the lower-arm drive and the case of the upper-arm drive. Even in this case, the estimating device can be appropriately changed by determining whether or not the reactor current ILx at the point X, which is the maximum value of the reactor current IL, is greater than or equal to zero.

The invention may be embodied in other specific forms without departing from the spirit or essential characteristics thereof. The present example is therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2012-074123 filed on Mar. 28, 2012 including the specification, claims, drawings and summary is incorporated herein by reference in its entirety.

1. An apparatus for controlling a voltage converting apparatus capable of performing one-arm drive using either a first arm including a first switching element or a second arm including a second switching element by alternatively switching on the first switching element and the second switching element each of which is connected to a reactor in series, said apparatus comprising:
a current detecting device for detecting a reactor current which is an electric current flowing through the reactor;
an average value estimating device for estimating an average value of the reactor current in units of periods of a gate signal for changing on and off of each of the first switching element and the second switching element, by using the detected reactor current; and
a controlling device for controlling operation of the voltage converting apparatus on the basis of the estimated average value of the reactor current.

2. The apparatus for controlling the voltage converting apparatus according to claim 1, wherein said average value estimating device has:
a first current amount calculating device for calculating a first current amount flowing through the reactor in a first period, by using the first period, which is from rise timing of the gate signal in which the reactor current becomes zero to fall timing of the gate signal, and the reactor current in the fall timing;
a zero timing calculating device for calculating timing in which the reactor current becomes zero, by using the reactor current in the fall timing and the reactor current immediately after the fall timing;
a second current amount calculating device for calculating a second current amount flowing through the reactor in a second period, by using the second period, which is from the fall timing to the timing in which the reactor current becomes zero, and the reactor current in the fall timing; and
an average value calculating device for calculating the average value of the reactor current, by using the first current amount, the second current amount, and one period of the gate signal.

3. The apparatus for controlling the voltage converting apparatus according to claim 2, comprising:
a second average value estimating device for estimating an intermediate value of the reactor current in the rise timing of the gate signal and the reactor current in the fall timing, as the average value of the reactor current;
a current value predicting device for predicting a reactor current in next rise timing by using the reactor current in the fall timing and the reactor current immediately after the fall timing; and
a changing device for changing which of said average value estimating device and said second average value estimating device is used, on the basis of the predicted reactor current.
